(19) United States
(12) Patent Application Publication
(10) Pub. No.: US 2012/0239344 A1
(43) Pub. Date: Sep. 20, 2012

(54) POSITION REGISTRATION APPARATUS, NON-TRANSITORY, COMPUTER READABLE STORAGE MEDIUM AND METHOD OF CONTROLLING POSITION REGISTRATION APPARATUS

(75) Inventor: Eiji HASEGAWA, Kawasaki (JP)

(73) Assignee: FUJITSU LIMITED, Kawasaki-shi (JP)

(21) Appl. No.: 13/408,697

(22) Filed: Feb. 29, 2012

(30) Foreign Application Priority Data
Mar. 18, 2011 (JP) 2011-060258

(51) Int. Cl. G06F 15/00

(52) U.S. Cl. 702/150

(57) ABSTRACT

A position registration apparatus recording a position where an event occurs, the apparatus has a detecting unit, a first position specifying unit that specifies a first position, a movement detecting unit that detects an amount of movement of the position registration apparatus, a memory that accumulates the amount of movement as movement information at least not before the detected event occurrence, and a second position specifying unit that specifies the amount of movement of the position registration apparatus from a point of time of the event occurrence up to a point of time of the information that specifies a position is acquired from outside of the position registration apparatus, and specifies a second position of the position registration apparatus at the point of time of the event occurrence based on the first position of the position registration apparatus and from the specified amount of movement of the position registration apparatus.

### CROSS-REFERENCE TO RELATED APPLICATION

This application is based upon and claims the benefit of priority of the prior Japanese Patent Application No. 2011-060258, filed on Mar. 18, 2011, the entire contents of which are incorporated herein by reference.

### FIELD

The embodiments discussed herein are related to a position registration apparatus for measuring position information.

### BACKGROUND

Devices such as car navigation systems and mobile terminal devices have functions to measure positions using radio signals from external devices such as radio field intensity and global positioning systems (GPS). These devices include functions to indicate the current position of a user, associate other information with positioning results, and display the positioning results.

However these devices consume electrical power while conducting reception and calculation processing to operate the positioning functions. Some devices perform the positioning functions intermittently to reduce the consumption of electrical power. Such devices are provided with acceleration and geomagnetic sensors and thus have a function to measure how much the device has moved from a position measured using radio waves from outside of the device. If the measurement functions are unusable, these types of devices specify a current position by correcting the position information derived up to that point using an amount of movement derived from acceleration and geomagnetic sensor information and the like.

Japanese Patent No. 3651598, Japanese Laid-open Patent Publication No. 2005-257284, and Japanese Laid-open Patent Publication No. 09-89584 are examples of the related art.

In some cases however, specifying a position of the device at the point of time when an event occurs, such as a position when taking a photograph or a position when a radio frequency identification (RF-ID) is read and the like, may be desired.

To allow for stable operation and to reduce non-operation due to a shortage of power and the like at the point of time an event occurs when a device is specifying a position along with an event occurrence, it is desirable that the processing is not conducted outside of the point of time the event occurs in order to suppress the electrical power consumption. It is desirable that measuring starts in tandem with the event occurrence in such a device. However, the device may not be able to receive external signals when the event occurs indoors or in a location where there is a lack of the desired amount of base stations for measuring. In such a case, the position may not be specified by the device with radio waves from outside the device.

Conventional devices measure a position at any previous point of time before the event occurrence as described above, but may not be able to specify the position at the point of time of the event occurrence if the amount of movement is not continuously measured from any of the previous points of time. As a result, when a conventional device is configured such that positioning is started after receiving radio waves from outside at the time of the event occurrence, there is a problem in that specifying the position at the point of time of the event occurrence may not be conducted if radio waves from outside is not received at the time of the event occurrence.

### SUMMARY

According to an aspect of the embodiment, a position registration apparatus that records a position where an event occurs, the apparatus has a detecting unit that detects an event occurrence, a first position specifying unit that specifies a first position by acquiring, from outside of the position registration apparatus, information that specifies a position, a movement detecting unit that detects an amount of movement of the position registration apparatus, a memory that accumulates the amount of movement detected by the movement detecting unit as movement information at least not before the detected event occurrence, and a second position specifying unit that, when the first position of the position registration apparatus is detected by the first position specifying unit, specifies the amount of movement of the position registration apparatus from a point of time of the event occurrence up to a point of time the information that specifies a position acquired from outside of the position registration apparatus, and specifies a second position of the position registration apparatus at the point of time of the event occurrence based on the first position of the position registration apparatus specified by the first position specifying device and from the specified amount of movement of the position registration apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram of the position registration device of the present embodiment.

FIG. 2 is an example of an event table.

FIG. 3 is an example of a position table.

FIG. 4 is an example of an event position table.

FIG. 5 is an example of a hardware configuration of a position registration device.

FIG. 6 is a flow chart of processing by an event management unit.

FIG. 7 is a flow chart of processing by a positioning control unit.

FIG. 8 describes a relation between the position registration device and the axes thereof.

FIG. 9 is an example of acceleration data in a time sequence.

FIG. 10 is a graph of acceleration data in a time sequence.

FIG. 11 is an example of directional data in a time sequence.

FIG. 12 is a graph of directional data in a time sequence.

FIG. 13 describes acquiring reception signal strength.

FIG. 14 is a configuration of a system for acquiring reception signal strength.

FIG. 15 is a relationship table of distance and radio field intensity from an access point.

FIG. 16 is a relationship table of access points and access point absolute position information.

FIG. 17 is an example of absolute position information.

FIG. 18 is a flow chart of processing by a position specifying unit.

FIG. 19 is a graph of a time sequence of an angle in the northern direction as seen from the z-axis based on the directional data illustrated in FIG. 10.

FIG. 20 illustrates a relationship between an orientation and axes of the position registration device.

FIG. 21 is an example of a screen indicating the position of an object.

FIG. 22 is a flow chart of processing by the positioning control unit according to a second embodiment.

FIG. 23 is a flow chart of processing by the positioning control unit according to the second embodiment.

FIG. 24 is time sequence data of absolute position information continuously acquired by the positioning control unit.

FIG. 25 is a graph illustrating changes in absolute coordinates acquired from time sequence data.

FIG. 26 is a waveform of acceleration data detected during a period corresponding to FIG. 24.

FIG. 27 describes a system according to a third embodiment.

FIG. 28 is an example of read information.

FIG. 29 is an example of installation location information.

FIG. 30 is an example of a hardware configuration of a position registration device according to the third embodiment.

FIG. 31 is a functional block diagram of the position registration device.

FIG. 32 is an example of an indoor environment according to the third embodiment.

FIG. 33 is an example of a graph of acceleration data at the time of or after the position registration device reads a radio IC tag of an object.

FIG. 34 is an example of a graph of directional data at the time of or after the position registration device reads the radio IC tag of the object.

### DESCRIPTION OF EMBODIMENTS

### Embodiment 1

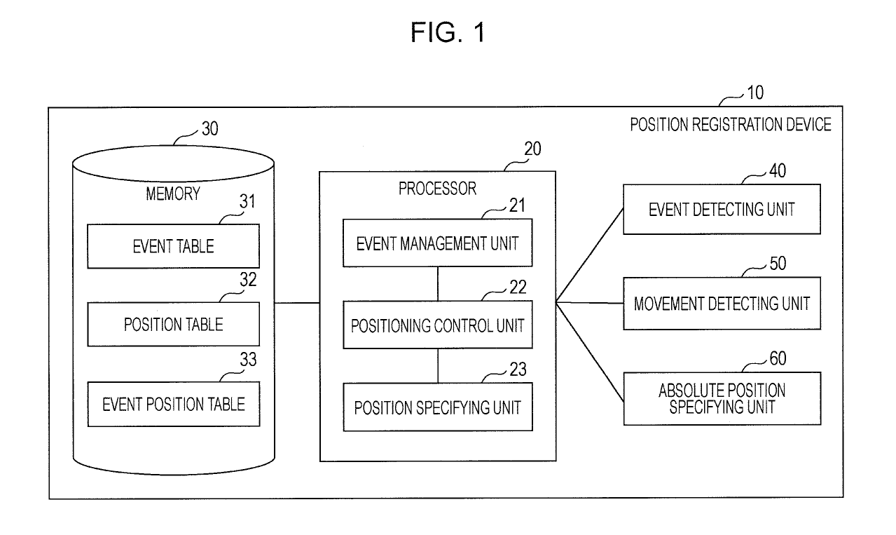

FIG. 1 is a functional block diagram of a position registration device of the present embodiment. A position registration device 10 is a device that can acquire information on the position of the position registration device 10 using a positioning function. The position registration device 10 includes a processor 20, a memory 30, an event detecting unit 40, a movement detecting unit 50, and an absolute position specifying unit 60.

The processor 20 that conducts processing related to positioning includes an event management unit 21, a positioning control unit 22, and a position specifying unit 23. The processor 20 is connected to the event detecting unit 40, the movement detecting unit 50, and the absolute position specifying unit 60.

The memory 30 stores information related to an event received from the processor 20 and information related to positioning and the like. The memory 30 includes an event table 31, a position table 32, and an event position table 33.

Now, each of the tables will be described.

The event table 31 is a table to temporarily store event information. An event indicates a phenomenon that becomes a trigger for processing conducted by the position registration device 10. The position registration device 10 can process multiple types of events. Such events include positioning events that are accompanied by processing to acquire position information, and events that are not accompanied by processing to acquire position information. Positioning events include, for example, acquiring image data, reading radio IC tags, reading bar code information, taking photographs, and receiving and sending email. In a positioning event of the present embodiment, processing to acquire position information of the position registration device 10 is conducted at the point of time the event occurs, but the position information is not needed immediately for the event. For example, a position of reading a radio IC tag attached to a stocktaking object may not be needed immediately when conducting stocktaking. However, a user may later easily search for the stocktaking object based on the position information if the position information is known. That is, the position information is available, but the user may not display that position information immediately. The position registration device 10 of the present embodiment is a terminal such as a mobile terminal or a camera that can be held and carried out by a user.

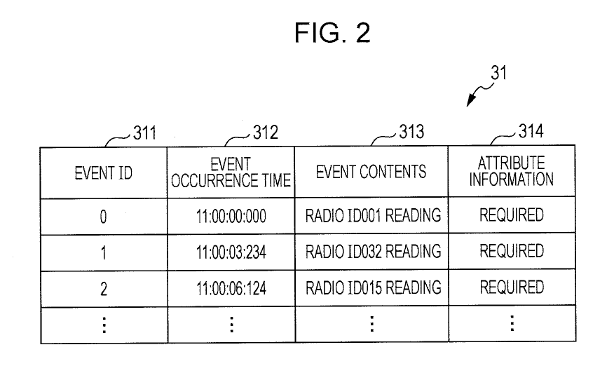

FIG. 2 is an example of the event table 31. Event information stored in the event table 31 includes an event identifier (event ID) 311 for identifying an event, event occurrence time 312, and event contents 313. The event information may also include attribute information 314 to indicate whether or not the event is a positioning event.

The event ID 311 is information for identifying an event. According to the present embodiment, the event table 31 stores the event information after the event is detected up to the time that the event occurrence position is specified, and the event contents 313 and the event occurrence position are associated with each other and stored in the event position table 33. The event table 31 stores multiple events if multiple events are detected up to the time when an absolute position of the position registration device 10 is specified after an event is first detected. An absolute position of the present embodiment indicates a position specified by acquiring from outside information that allows for the specification of a position of the position registration device. The event identifiers 311 are added to the event information for identifying multiple events.

The event occurrence time 312 is the point of time at which an event occurs. In the present embodiment, a time acquired from an internal clock at the point of time that the event detecting unit 40 detects the event corresponds to the event occurrence time.

The event contents 313 is information to identify the contents of the positioning event. The positioning event of the present embodiment is reading a radio IC tag.

The first record in the event table 31 of FIG. 2 indicates that a radio IC tag reading event with an identifier 001 was detected at the time 11:00:00:000.

The position table 32 is a table for storing time sequence movement information that includes a movement direction and a movement distance of the position registration device 10 detected by the movement detecting unit 50, and absolute position information detected by the absolute position specifying unit 60. Movement information according to the present embodiment includes acceleration data and magnetic flux density data that can be used to calculate the movement direction and the movement distance. In the present embodiment, movement information detected by the movement detecting unit 50 at least at or after the event occurrence time is accumulated. A movement amount refers to the combination of the movement direction and the movement distance.

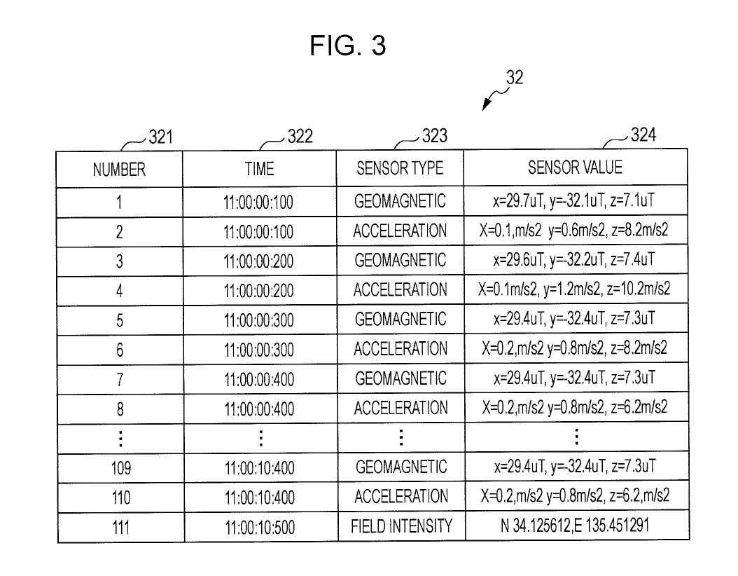

FIG. 3 is an example of a position table 32. The position table 32 has information including a number 321, a time 322, a type of sensor 323, and a sensor value 324.

The number 321 is an identifier for identifying records of movement information and absolute position information in the position table 32. The time 322 indicates times that the movement detecting unit 50 acquired the acceleration and the magnetic flux density data and times that the absolute position specifying unit 60 acquired the absolute position information.

The sensor type 323 is information for specifying the type of sensor used for detecting the movement information and the absolute position information. The movement detecting unit 50 uses an acceleration sensor 106 to measure acceleration, and a geomagnetic sensor 107 to measure magnetic flux density. The absolute position specifying unit 60 detects the radio field intensity of received radio waves. The absolute position specifying unit 60 calculates the absolute position from the radio field intensity of the received radio waves. The sensor value 324 is a result of the measurements by the respective sensors. “m/s2” in the position table 32 refers to the units for acceleration (m/s²).

The event position table 33 is a table for associating an event with a position of the position registration device 10 at the time the event occurs.

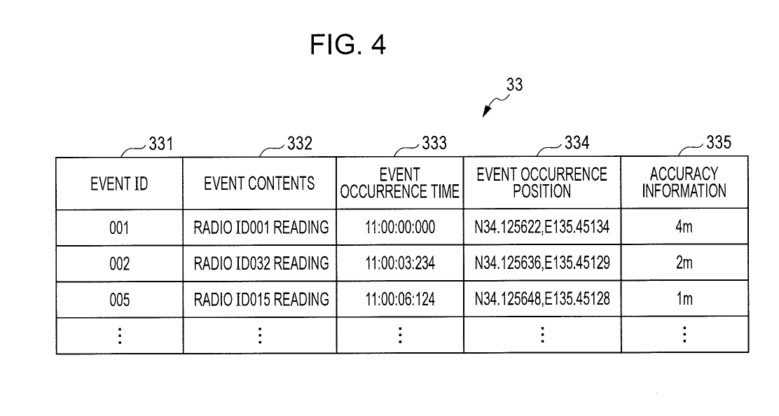

FIG. 4 is an example of the event position table 33.

An event ID 331 is information for identifying an event corresponding to the event ID 311 in the event table 31. Event contents 332 is information for identifying the contents of an event corresponding to the event contents 313 in the event table 31. The event occurrence time 333 is information indicating the time an event occurs corresponding to the event occurrence time 312 in event table 31. The event occurrence position 334 is information indicating an absolute position of the position registration device 10 at the event occurrence time. Accuracy information 335 is information indicating the size of an error created when the event occurrence position 334 is specified.

The event detecting unit 40 of the position registration device 10 in FIG. 1 detects that an event has occurred. The event detecting unit 40 outputs event occurrence information indicating that an event has occurred to the processor 20. The event detecting unit 40 may also output the event occurrence information only when a positioning event is detected.

The movement detecting unit 50 of the position registration device 10 acquires positioning results that can specify movement of the position registration device 10 by causing the sensors for detecting movement of the position registration device 10 to operate. The movement information is assumed to be the positioning results acquired by the movement detecting unit 50. The position of the position registration device 10 at the point of time when the occurrence of the positioning event occurs is unknown. The movement detecting unit 50 activates the sensors upon receiving a positioning start instruction from the processor 20, and then detects movement. The movement detecting unit 50 stops the supply of power to the sensors upon receiving a positioning stop instruction. The movement detecting unit 50 outputs the acquired movement information to the processor 20.

The absolute position specifying unit 60 of the position registration device 10 detects positioning results that can specify the absolute position of the position registration device 10. In the first embodiment, signals that can specify positions are radio field intensity signals received from multiple access points. The absolute position specifying unit 60 calculates absolute position information from the radio field intensities. The absolute position specifying unit 60 also starts positioning upon receiving a positioning start instruction from the processor 20, and stops positioning upon receiving a positioning stop instruction. The absolute position specifying unit 60 outputs the acquired positioning results to the processor 20.

The event management unit 21 of the processor 20 manages the event information. The event management unit 21 creates the event information upon receiving the event occurrence information from the event detecting unit 40. The event management unit 21 also stores the created event information in the event table 31. The event management unit 21 outputs instructions to start positioning to the positioning control unit 22.

The positioning control unit 22 of the processor 20 controls the positioning processing of the position registration device 10. The positioning processing of the present embodiment includes two types of processing: acquiring movement information by the movement detecting unit 50 for calculating movement of the position registration device 10, and acquiring absolute position information of the position registration device 10 by the absolute position specifying unit 60. The positioning control unit 22 controls the operations of the movement detecting unit 50 and the absolute position specifying unit 60 to perform positioning. Specifically, the positioning control unit 22 outputs instructions to start positioning to the movement detecting unit 50 and the absolute position specifying unit 60 upon receiving a request to start positioning from the event detecting unit 40. If the movement detecting unit 50 and the absolute position specifying unit 60 have already started positioning, the positioning control unit 22 is capable of not outputting the instructions to start positioning. The positioning control unit 22 stores the absolute position information in the position table 32 of the memory 30 upon receiving the movement information from the movement detecting unit 50 and the absolute position information from the absolute position specifying unit 60. The positioning control unit 22 outputs a position specifying instruction to the position specifying unit 23 upon acquiring the absolute position information from the absolute position specifying unit 60.

The position registration device 10 causes the positioning functions to be stopped by not supplying power to the positioning functions during normal times to save electrical power. That is, the movement detecting unit 50 and the absolute position specifying unit 60 for implementing the positioning functions are stopped during normal times. The position registration device 10 activates the movement detecting unit 50 and the absolute position specifying unit 60 when conducting positioning. The movement detecting unit 50 and the absolute position specifying unit 60 begin positioning after being activated. Herein the positioning control unit 22 sends out a request to the absolute position specifying unit 60 to measure the absolute position, and sends out a request to the movement detecting unit 50 to detect the movement information. The absolute position specifying unit 60 and the movement detecting unit 50 start positioning and detecting respectively. Activation of the movement detecting unit 50 is completed in a shorter time than activation of the absolute position specifying unit 60 and then the movement information of the position registration device 10 is acquired. A certain amount of time is consumed from when the absolute position specifying unit 60 starts position capture processing to when the position is captured. For example, frames having specific information are received when measuring by using GPS. It takes several tens of seconds for a device to receive such frames.

The position registration device 10 according to the present embodiment specifies variations of the position registration device 10 in the time period until the position is captured based on the movement information of the position registration device 10 detected by the movement detecting unit 50.

The position specifying unit 23 specifies the position of the position registration device 10 at the event occurrence time from the absolute position information and the movement information accumulated in the position table 32. For example, the position registration device 10 specifies the movement amount including the movement direction and moving distance of the position registration device 10 up to the point of time that the information that can specify the position of the position registration device 10 from the event occurrence time is acquired from outside, and then specifies the event occurrence position by correcting the position of the position registration device 10 using the movement amount of the position registration device 10 based on the movement information accumulated in the position table 32.

The position specifying unit 23 also may save accuracy information and the like of the position of the position registration device 10 at the event occurrence time along with the specified position information. By saving accuracy information, the position specifying unit 23 may, for example, correct the event occurrence position using the accuracy information and shelf location information and display that fact that an error is included in the position information to the user when specifying a position of an object afterward.

If shelf location information or map information is available beforehand, the position specifying unit 23 may shift the position to a position in which the event could have occurred. For example, when the position specifying unit 23 specifies that the position registration device 10 is at a position that is not on a map, the event occurrence position may be changed to a position that is on the map. Such information for determining whether or not the position is a position in which an event can occur is previously associated with the map information.

Next, a hardware configuration of the position registration device 10 will be described.

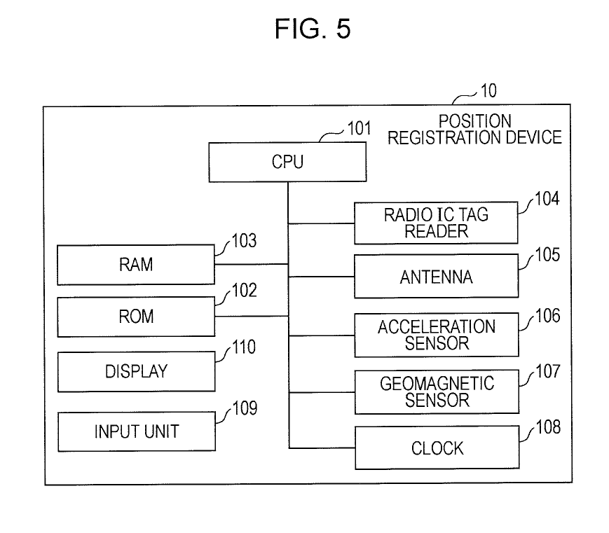

FIG. 5 is an example of a hardware configuration of the position registration device 10.

The position registration device illustrated in FIG. 5 includes a CPU 101, a ROM 102, a RAM 103, a radio IC tag reader 104, an antenna 105, the acceleration sensor 106, the geomagnetic sensor 107, a clock 108, an input unit 109, and a display 110, all of which are interconnected by a bus.

The CPU 101 is a central processing device that controls all the operations of the position registration device 10. The CPU 101 is an example of the processor 20 in the present embodiment. Although the CPU 101 according to the present embodiment performs all the processing, processing may also be conducted by individual processors such as, for example, a converting processor that converts between analog and digital, an image output processor that outputs images, and a detecting processor that detects the input of signals.

The ROM (Read Only Memory) 102 is a non-volatile recording medium and stores control programs for allowing the CPU 101 to conduct various control operations. The ROM 102 already stores control programs executed by the CPU 101 and various types of control parameters. The CPU 101 may read out and conduct applications from a recording medium such as an external semiconductor memory or a CD-ROM and the like.

The RAM (Random Access Memory) 103 is a temporary storage region which is used when the CPU 101 executes the control programs. The CPU 101 reads out the control programs stored in the ROM 102 into the RAM 103 to start executing the control programs. The RAM 103 is an example of the memory 30.

The radio IC tag reader 104 is a reader to read out information stored in a radio IC tag. The radio IC tag reader 104 is an example of the event detecting unit 40. The radio IC tag is previously attached to an object for stocktaking.

The antenna 105 sends out and receives from radio waves. The combination of the antenna 105 and the CPU 101 is an example of the absolute position specifying unit 60. The position registration device 10 can communicate data to and from an external server via the antenna 105.

The acceleration sensor 106 detects acceleration of the position registration device 10. Acceleration sensors are generally divided into three types: mechanical, optical and solid state types. The solid state type may be a capacitance type, a piezo-resistance type, or a gas temperature distribution type. The acceleration sensor 106 outputs, for example, a voltage to specify the detected acceleration. The acceleration sensor 106 according to the present embodiment outputs voltages that indicate accelerations in triaxial directions. The CPU 101 specifies acceleration data in the respective axial directions based on the voltage values of the axial directions outputted by the acceleration sensor 106.

The geomagnetic sensor 107 detects a magnetic field received by the position registration device 10 from outside. The geomagnetic sensor 107 according to the present embodiment detects, for example, geomagnetism. The geomagnetic sensor 107 outputs, for example, a voltage that can specify the detected geomagnetism. The geomagnetic sensor 107 may also output information indicating the magnitude of magnetic flux density.

The geomagnetic sensor 107 according to the present embodiment outputs information indicating magnetic flux densities in each of the triaxial directions. The CPU 101 specifies the magnetic flux densities in each of the triaxial directions based on the information indicating the magnetic flux densities in each of the triaxial directions outputted by the geomagnetic sensor 107.

The combination of the acceleration sensor 106, the geomagnetic sensor 107, and the CPU 101 is an example of the movement detecting unit 50.

The clock 108 is an internal timepiece of the position registration device 10. In the present embodiment, the event occurrence time and the time when the absolute position information is received is specified based on the time of the clock 108. The time of the clock 108 may be corrected according to signals from outside.

When GPS and the like is used, the absolute position specifying unit 60 conducts positioning by using the GPS from the point of time of the event occurrence. The position registration device 10 may correct the time of the clock 108 by using GPS signals. At this time, acquiring data may be continued at the uncorrected time until the event occurrence position is specified by the position specifying unit 23. This is because the time at the point of time of the event occurrence outputted by the clock 108 has a different reference than the time outputted by the clock 108 at the point of time the absolute position specifying unit 60 detects the absolute position, due to the correction of the time. For example, the absolute position specifying unit 60 may specify a difference between the uncorrected time and the corrected time of the clock 108 and then re-correct the corrected time using the specified difference when recording in the position table 32 and then record the re-corrected time. With this configuration, even when the time is corrected, the past records stored in the position table 32 and the records to be recorded thereafter can have a uniform time reference.

The display 110 is a unit to display images, videos, data and the like. The input unit 109 is a unit to detect signals by being pressed from outside. The input unit 109 may be a switch or a touch panel and the like. For example, the position registration device 10 may be a combination of the display 110 and a touch panel. The position registration device 10 displays icons and the like on the display 110. When a user touches a displayed icon through the touch panel, the coordinates touched by the user are outputted by the touch panel. The position registration device 10 executes a command indicated on the display according to the outputted coordinates.

Specifically, the position registration device 10 outputs an interruption signal to the CPU 101 when it is detected that the touch panel has been touched. The CPU 101 conducts processing corresponding to the interruption signal upon receiving the interruption signal.

Processing of the position registration device 10 will be described next. The following processing will be described with an example in which the position registration device 10 is used for object stocktaking work. The radio IC tags are previously attached to the objects in the stocktaking work. The position registration device 10 can read out tag information stored in the radio IC tag. The stocktaking user uses the position registration device 10 to read the tag information stored in the radio IC tag attached to the object. The position registration device 10 stores the read tag information in the RAM 103 of the position registration device 10. By associating the tag information with the position information when the radio IC tag was read out, the user can conveniently search for the object afterward.

The position registration device 10 according to the present embodiment does not perform positioning functions at normal times. Specifically, the position registration device 10 does not supply power for the positioning functions.

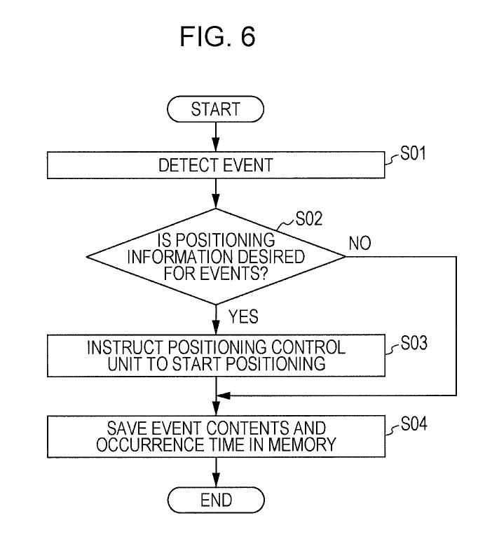

FIG. 6 is a flow chart of processing by an event management unit 21.

The event detecting unit 40 detects an event. The event detecting unit 40 detects the event due to the reading of the tag information by the position registration device 10. The event detecting unit 40 outputs the fact that the an event was detected to the processor 20.

The event management unit 21 of the processor 20 receives the information indicating the detection of the event from the event detecting unit 40 (S01). The event management unit determines whether or not the event received from the event detecting unit 40 is a positioning event (S02). For example, if the position registration device 10 can conduct multiple types of events, classifying information, in which events are classified according to whether or not the events are positioning events accompanied with positioning, is associated with each event ID beforehand. When the event management unit 21 acquires the event occurrence information, whether or not the event is a positioning event can be determined from the classifying information and the type of event included in the acquired event occurrence information. In the present embodiment, conducting the processing of reading tag information stored in a radio IC tag attached to an object is previously defined.

The event management unit 21 outputs a request to start positioning to the positioning control unit 22 to acquire position information if the event is a positioning event (S03).

The event management unit 21 assigns the event ID 311 to the event having the event occurrence time 312 and the event contents 313, and then stores the information in the event table 31 (S04).

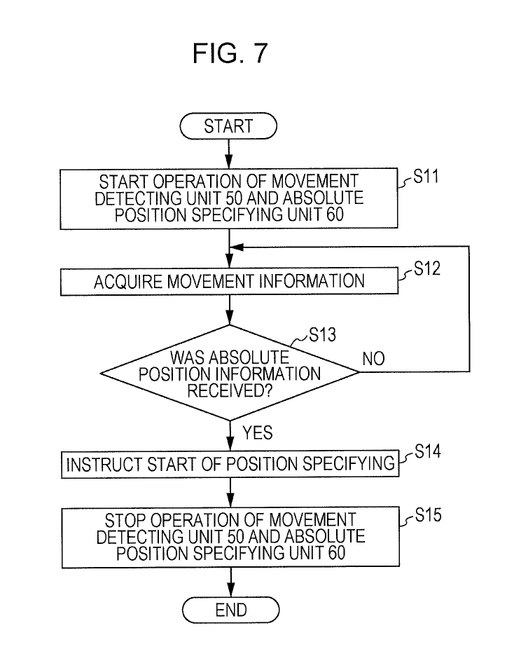

Processing of the positioning control unit 22 will be described next. FIG. 7 is a flow chart of processing by the positioning control unit 22.

The positioning control unit 22 requests the movement detecting unit 50 and the absolute position specifying unit 60 to start positioning upon receiving the instruction to start positioning from the event management unit 21 (S11).

Herein, the positioning control unit 22 sends out a request to the absolute position specifying unit 60 to measure the absolute position, and sends out a request to the movement detecting unit 50 to detect the movement information. The absolute position specifying unit 60 and the movement detecting unit 50 start positioning and detecting respectively. The absolute position specifying unit 60 conducts absolute position measuring which includes receiving and analyzing radio waves for detecting the absolute position.

A certain amount of time is consumed for absolute position measuring from the start of the position measuring to capturing the position. Therefore, the time taken for switching the acceleration sensor 106 and the geomagnetic sensor 107 from an idle state to a functioning state in which movement information can be acquired is shorter than the time taken from starting to measure the absolute position information until the position is captured.

The movement detecting unit 50 calculates acceleration data from a voltage that indicates the magnitude of the acceleration each time the voltage indicating the acceleration is outputted by the acceleration sensor 106, and then outputs the data to the positioning control unit 22. The movement detecting unit 50 also calculates magnetic flux density data from a voltage that indicates the magnitude of the magnetic flux density each time the voltage indicating the magnetic flux density is outputted by the geomagnetic sensor 107, and then outputs the data to the positioning control unit 22. The movement detecting unit 50 may output a voltage value indicating the acceleration and a voltage value indicating the magnitude of the magnetic flux density so that acceleration data and magnetic flux density data may be computed when the position specifying is conducted by the position specifying unit 23. The movement detecting unit 50 may also periodically acquire outputs from the acceleration sensor 106 and the geomagnetic sensor 107.

The positioning control unit 22 periodically receives values (movement information) relating to the movement of the position registration device 10 from the movement detecting unit 50 (S12). The movement information may include, for example, acceleration applied to the position registration device 10 or magnetic flux density of the position registration device 10 or the like. The positioning control unit 22 stores the acquired movement information in the position table 32. Processing to acquire the movement information is described below.

The positioning control unit 22 determines whether or not the absolute position specifying unit 60 has detected the absolute position information (S13). If the absolute position information is not detected (S13: No), the positioning control unit continues the operation in S12 until the movement information is acquired. Therefore, acquiring the movement information is continued until the absolute position specifying unit 60 detects the absolute position information. Processing to acquire the absolute position information is described below.

If the absolute position information is detected (S13: Yes), the positioning control unit 22 instructs the position specifying unit 23 to start processing to specify the event occurrence position (S14). The positioning control unit 22 also stores the acquired absolute position information in the position table 32.

The positioning control unit 22 stops the operations of the movement detecting unit 50 and the absolute position specifying unit 60 (S15). After measuring of the absolute position is completed, the consumption of electrical power can be suppressed by stopping the operations of the movement detecting unit 50 and the absolute position specifying unit 60. The position registration device 10 may also stop the position information acquiring functions when acquiring of the position information corresponding to the event is completed. The positioning control unit 22 may place the movement detecting unit 50 and the absolute position specifying unit 60 in an energy-saving state, or may stop the supply of power to the movement detecting unit 50 and the absolute position specifying unit 60. Since the position registration device 10 can place the movement detecting unit 50 and the absolute position specifying unit 60 into an energy-saving state after the positioning is completed, the power consumption of the position registration device 10 can be reduced.

[Movement Information Acquisition Processing]

Processing for acquiring the movement information will be described herein.

The movement detecting unit 50 starts to acquire the movement information upon receiving the positioning processing start request sent out by the positioning control unit 22. Specifically, the acceleration sensor 106 and the geomagnetic sensor 107 are supplied with electrical power.

The acceleration sensor 106 outputs voltages indicating acceleration magnitudes for each of the three axial directions when the electrical power is supplied. The geomagnetic sensor 107 also outputs voltages indicating magnetic flux density magnitudes for each of the three axial directions when the electrical power is supplied.

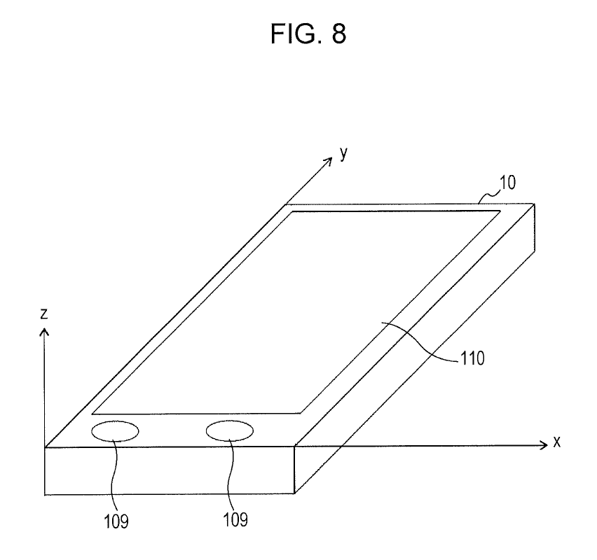

The three axial directions of the acceleration sensor 106 and the geomagnetic sensor 107 mounted on the position registration device 10 will be described. FIG. 8 describes a relation between the position registration device 10 and the axes thereof. The “x”, “y”, and “z” in FIG. 8 indicate the x-axis, the y-axis, and the z-axis of the position registration device 10 respectively. The acceleration sensor 106 and the geomagnetic sensor 107 are mounted on the position registration device 10 such that the respective x, y, and z axes of the sensors correspond to the x, y, and z axes of the position registration device 10. The display 110 and the input unit 109 are arranged on the plane of the z-axis direction of the position registration device 10 in the present embodiment.

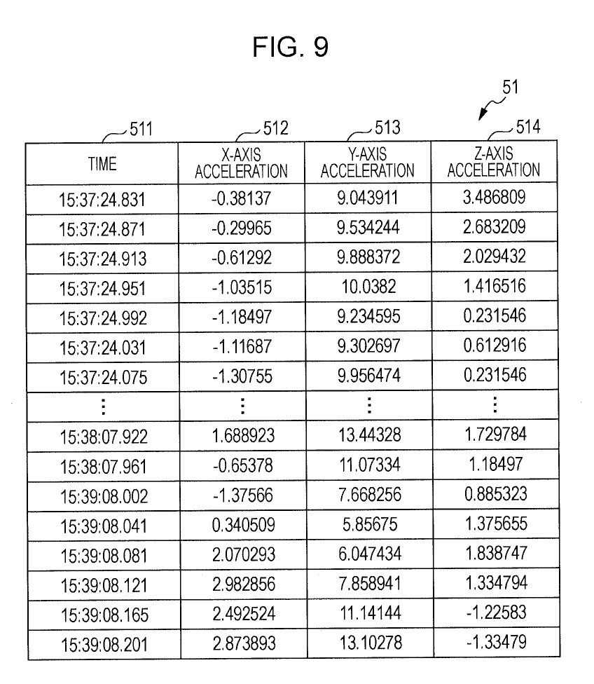

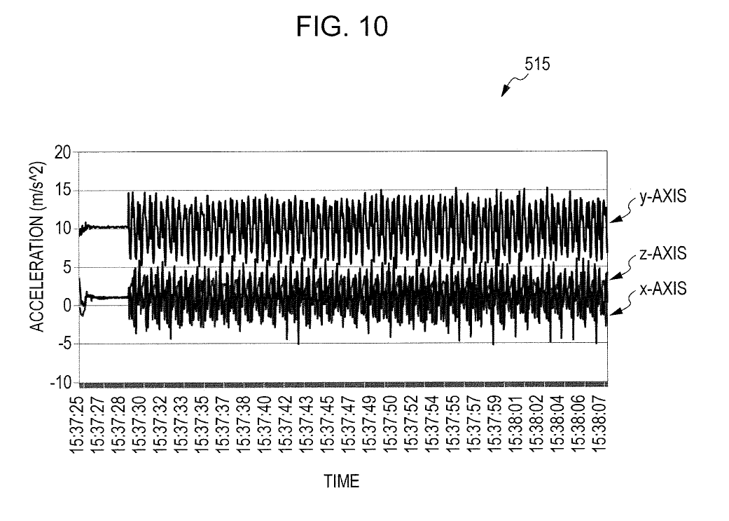

FIG. 9 is an example of acceleration data in a time sequence. Acceleration data 51 includes a time 511 at which acceleration is detected, and acceleration values 512, 513, and 514 of the respective x-axis, y-axis, and z-axis directions. For example, the acceleration sensor 106 outputs voltages that can be converted to acceleration. The movement detecting unit 50 converts the outputs received from the acceleration sensor 106 into acceleration data. FIG. 10 is a graph 515 of the acceleration data 51 in a time sequence. The movement detecting unit 50 stores the converted acceleration data for each of the axial directions and the times received from the acceleration sensor 106 in the position table 32.

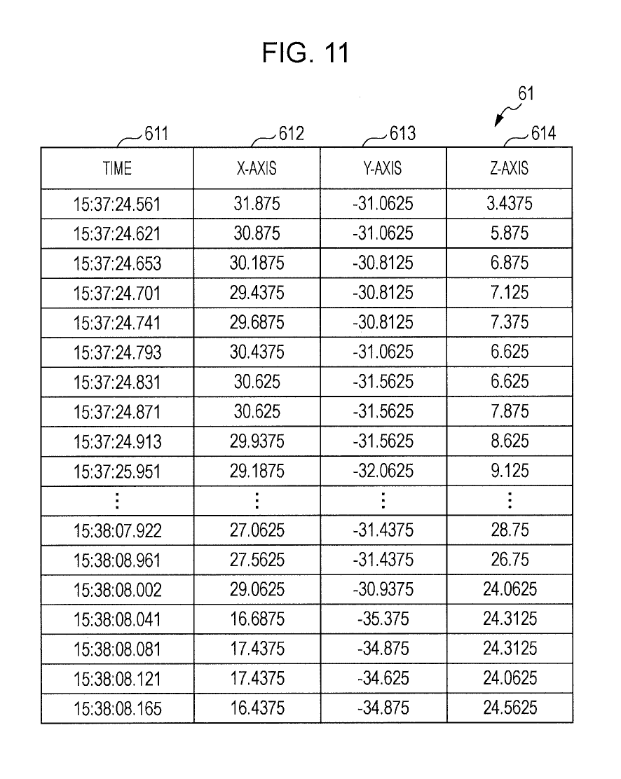

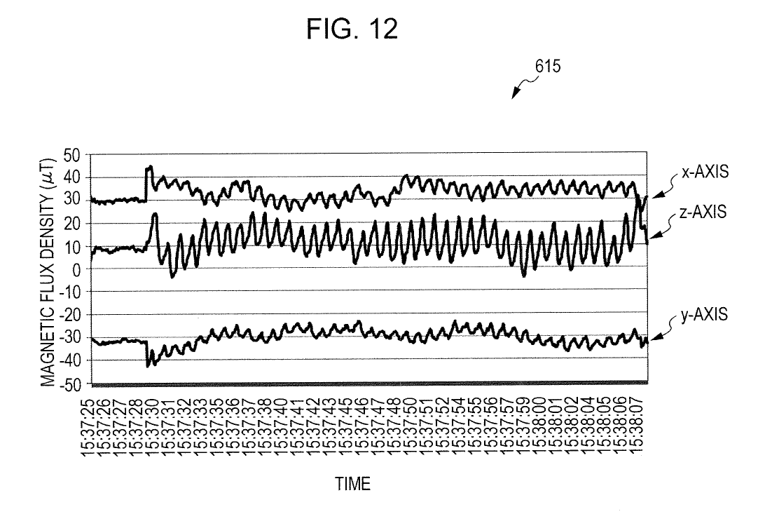

FIG. 11 is an example of directional data in a time sequence. Directional data 61 includes a time 611 at which the directional data is detected, and magnetic flux density values 612, 613, and 614 of the respective x-axis, y-axis, and z-axis directions. For example, the geomagnetic sensor 107 outputs voltages that can be converted into magnetic flux density. The movement detecting unit 50 converts the outputs received from the geomagnetic sensor 107 into magnetic flux densities. FIG. 12 is a graph 615 of the directional data 61 in a time sequence. The movement detecting unit 50 stores the converted magnetic flux density data for each of the axial directions and the times received from the geomagnetic sensor 107 in the position table 32.

Additionally, the position registration device 10 may be equipped with a gyro sensor so that rotation speed of the position registration device 10 can be acquired by the gyro sensor. The gyro sensor can detect a change in the direction to which a user is walking even if conditions are not ideal for allowing geomagnetism to be acquired. Acquiring rotation movement of the position registration device 10 is more accurate than acquiring geomagnetism since the gyro is less dependent on environmental conditions.

[Absolute Position Information Acquisition Processing]

Acquiring absolute position will be described next. The absolute position of the position registration device 10 is specified by analysis conducted by the position registration device 10 on signals acquired by wireless and radio waves from outside. Methods to acquire an absolute position include positioning based on radio field intensity sent out from access points, positioning based on the time that signals from access points are received, positioning based on GPS, positioning using radio wave phase differences, or a method to confirm a position by reading terminal information from an environment. In the present embodiment, the position registration device 10 acquires its absolute position by using received signal strength indicators (RSSI). The absolute position specifying unit 60, for example, specifies absolute position information from radio field intensities sent from multiple access points.

When the absolute position specifying unit 60 conducts positioning, for example, using GPS or wireless strength, a certain amount of time is taken to activate the positioning functions and then capture the current position since processing such as capturing satellite radio waves and receiving radio waves sent out from access points is conducted. Therefore, the absolute position specifying unit 60 specifies position information that indicates a position different from the position at the time of the event occurrence in the device when the device moves during the time the position is being specified even if the event occurrence and the positioning functions are activated.

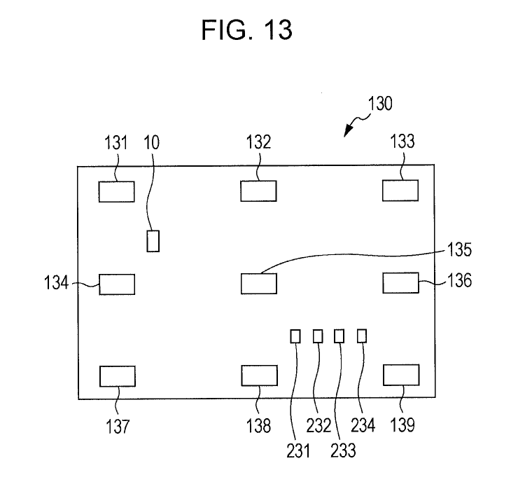

FIG. 13 describes acquiring reception signal strength. In FIG. 13, multiple access points 131, 132, 133, 134, 135, 136, 137, 138, and 139 are installed in a room 130. Multiple objects 231, 232, 233, and 234 are also placed in the room 130.

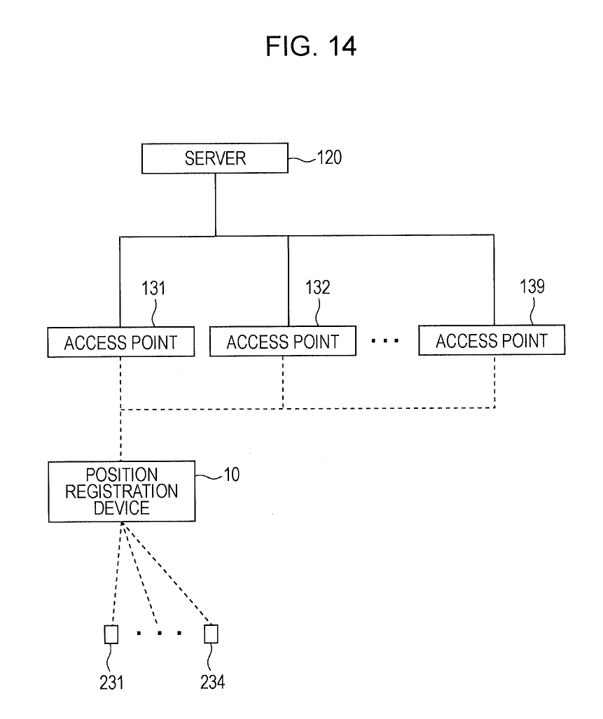

FIG. 14 is a configuration of a system for acquiring reception signal strength.

Access points 131, 132, and 139 are devices for conducting radio communication with the position registration device 10, and correspond to the access points in FIG. 13.

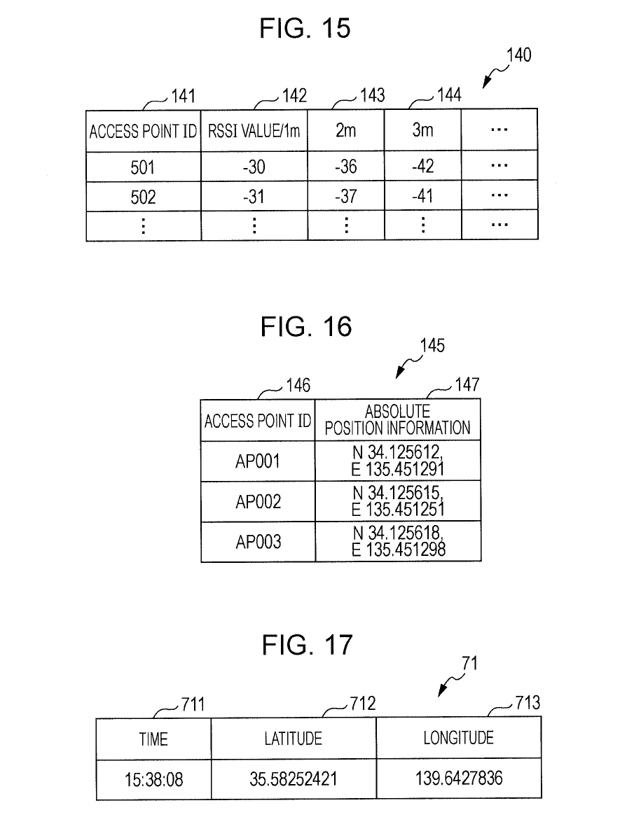

A server 120 stores the radio field intensities and the absolute position information of the multiple access points 131 to 139. FIG. 15 is a relationship table 140 of distance and radio field intensity from an access point. The table 140 includes an access point ID 141 that identifies an access point, and RSSI values (dB/m) 142, 143, and 144 that correspond to distances from the access points. The server 120 stores the absolute position information of the multiple access points 131 to 139 beforehand. FIG. 16 is a relationship table 145 of access points and access point absolute position information. The table 145 includes an access point ID 146 that identifies an access point, and absolute position information 147 that indicates access point position coordinates.

When positioning the absolute position, the position registration device 10 receives radio waves from the multiple access points 131 to 139. The position registration device 10 acquires the signal strengths (RSSI values) of the radio waves from the access points 131 to 139 at this time. Upon receiving the radio field intensities of the three access points, the position registration device 10 sends out the received access point identification information and radio field intensity information to the server 120.

The position registration device 10 establishes the time at which receiving the radio field intensities from the multiple access points that can be used for positioning is completed as the time at which the absolute position is specified. Specifically, the time at which the absolute position is specified is the point of time in which information that can specify the position is received from outside. The position registration device 10 may establish the time at which the access point identification information and the radio field intensity information are sent to the server 120 as the time at which the absolute position is specified if the time to complete the period from receiving the radio field intensity to sending out the information to the server 120 is a short time. Thus even when time is taken to conduct the positioning computing in the server 120, the time at which the absolute position of the position registration device 10 is acquired may be indicated as the correct time when using this configuration.

The server 120 specifies the absolute position information 147 of the access points from the relationship table 145. The server 120 uses the radio field intensity information of the access points and the relationship table 140 to specify the position of the position registration device 10 using, for example, a triangulation method. The server 120 sends out the specified absolute position information of the position registration device 10 to the position registration device 10.

As described above, the absolute position specifying unit 60 of the position registration device 10 acquires the time at which the absolute position is specified and the absolute position information acquired from the server 120. FIG. 17 is an example of absolute position information. Absolute position information 71 includes a time 711 at which the absolute position information is specified and coordinate information (latitude 712, longitude 713) that indicates the absolute position. Besides latitude and longitude, the coordinate information may be written in various ways such as, for example, an ID indicating a room, a north, east, south, or west movement distance from an entrance, or a movement distance in an east-west direction. However, latitude and longitude are used in the present embodiment.

When the absolute position is acquired by receiving signals from outside, radio waves may not be able to be acquired when starting the positioning.

For example, positioning by GPS may not be possible when the position registration device 10 is inside a room. Moreover, there may not be enough access points for positioning due to the location of the position registration device 10 if positioning is conducted by using radio field intensity of wireless LAN or Bluetooth and the like. In these cases, the position registration device 10 takes a certain amount of time from the start of positioning to the acquisition of the information for acquiring the absolute position information.

Furthermore, radio waves may be reflected by another object or an interruption may occur before the position registration device 10 is finished when receiving the radio waves. In this case, the correct position may not be specified even when triangulation is conducted based on radio waves from multiple access points or satellites.

When these types of conditions occur, the position registration device 10 continuously acquires movement information until suitably accurate absolute position information can be acquired. When the suitably accurate absolute position information is acquired, the position registration device 10 can specify the event occurrence position from the suitably accurate absolute position information and the movement information.

Whether or not the accuracy of the absolute position information is suitable or not can be determined, for example, by using much absolute position information acquired by the position registration device 10 and then determining whether or not the absolute position information falls within a previously acquired statistical information distribution range.

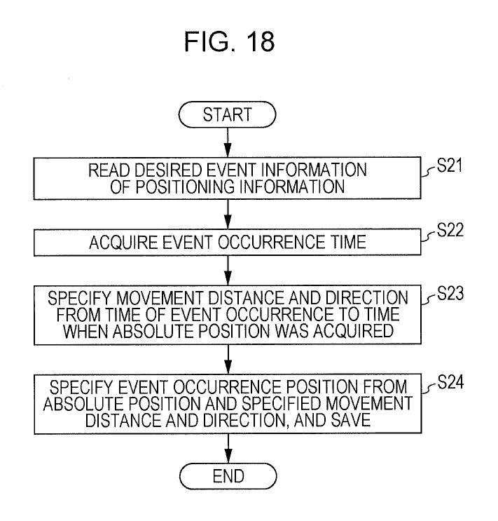

Processing of the position specifying unit 23 will be described next. FIG. 18 is a flow chart of processing by the position specifying unit 23. The positioning control unit 22 outputs a request to start the position specifying processing to the position specifying unit 23 upon acquiring the absolute position information from the absolute position specifying unit 60. The position specifying unit 23 starts the processing to specify the position upon receiving the request to start the position specifying processing. The position specifying unit 23 estimates a position (event occurrence position) of the position registration device 10 at the event occurrence time from the movement information in a time sequence and the absolute position information stored in the position table 32. The position specifying unit 23 specifies the movement distance and the movement direction of the position registration device 10 during the time period from the event occurrence time to the time when the absolute position information is acquired based on the time sequence movement information. The position specifying unit 23 then specifies a position that indicates movement in the opposite direction only for the specified movement distance from the absolute position information acquired by the absolute position specifying unit 60, as the position at the event occurrence time. Each of steps will be described below.

The position specifying unit 23 reads out the positioning event based on the positioning information from the event table 31 (S21). The position specifying unit 23 extracts the time information at the time the event occurred (event occurrence time) from the read event (S22).

The position specifying unit 23 specifies the movement distance and the movement direction of the position registration device 10 from the event occurrence time to the time the absolute position information was acquired based on the event occurrence time in the extracted event information and on the movement information and the absolute position information stored in the position table 32 (S23).

The following description is based on the examples in FIG. 9 and FIG. 11. It is assumed that the event detecting unit 40 detects an event of reading tag information from a radio IC tag at 15:37:24. The position registration device 10 starts to acquire acceleration data and directional data via the event management unit 21 and the positioning control unit 22 from the point of time at which the event detecting unit 40 detected the event. As a result, data at and after the time 15:37:24 can be acquired. The positioning control unit 22 continues to acquire the acceleration data and the directional data until the absolute position information is acquired. It is assumed that the absolute position specifying unit 60 successfully captures the absolute position information of the position registration device 10 at the point of time 15:38:08. As a result, the absolute position information (latitude and longitude) of the position registration device 10 is acquired.

The position specifying unit 23 specifies the movement amount (movement distance and movement direction) of the position registration device 10 from the event occurrence time (15:37:24) to the time the absolute position was verified (15:38:08) based on the acquired time sequence movement information (acceleration data and directional data).

Processing to specify the movement amount conducted by the position specifying unit 23 will be described next.

[Position Registration Device 10 Movement Distance]

The position specifying unit 23 specifies the movement distance of the position registration device 10 according to the number of steps of the user. The position specifying unit 23 detects walking by the user and the number of steps from fluctuations in the time sequence acceleration data. The waveform of the time sequence acceleration data appears as illustrated in FIG. 10 when the user walks. The position specifying unit 23 specifies, for example, one step by the user when one wave is larger than a certain amplitude. Additionally, the position specifying unit 23 can base the determination on whether or not the period of a wave falls within a certain range.

In the present embodiment, the position specifying unit 23 calculates the number of times fluctuations of a value determined from amplitudes of the acceleration data or the like exceeds a threshold. In the case illustrated in FIG. 9, the position specifying unit 23 specifies that the user took 82 steps. The position registration device 10 is assumed to have acquired the average stride information of the user beforehand. In the present embodiment, the average stride of the user is 75 cm. In this case, the position specifying unit 23 estimates the movement to be 0.75 (m)×82 (steps)=61.5 m.

The position specifying unit 23 specifies the movement direction of the position registration device 10 with the following procedures.

The user is assumed to be walking and carrying the position registration device 10. Accelerating and decelerating are repeated while walking since the walking speed falls when the user's feet touch the ground. The time that a foot touches the ground corresponds to a time when the acceleration reaches the upward peak in the gravitational force direction. The deceleration direction at the time when the acceleration reaches the upward peak in the gravitational force direction corresponds to the major direction of negative acceleration. Next, the position registration device 10 acquires a relatively gentle positive acceleration based on the energy of the user's feet. The position specifying unit 23 uses the above walking characteristics to specify the movement direction of the position registration device 10.

The position specifying unit 23 specifies the upward acceleration peak of the gravitational force direction from the acceleration data 51. The position specifying unit 23 at this time specifies the direction when acceleration in the horizontal direction becomes the negative peak. The position specifying unit 23 uses the x, y, and z axes of the position registration device 10 to specify the direction. The specified direction represents the direction opposite the movement direction of the position registration device 10.

Additionally, the position specifying unit 23 may use the x, y, and z axes to specify the positive acceleration direction in the horizontal direction on or after the gravitational force direction upward acceleration peak is detected.

According to the above description, the position specifying unit 23 can use the x, y, and z axes to specify a direction in which the position registration device 10 has moved.

In another method, a facing direction of the screen of the position registration device 10 may be determined as the movement direction if it is assumed that the user is looking at the screen. The position registration device 10 according to the present embodiment has the display 110 in the z-axis direction. In this case, the position specifying unit 23 specifies the direction facing the z-axis as the walking forward direction.

[Position Registration Device 10 Orientation]

Next, the position registration device 10 specifies an orientation of the position registration device 10 in relation to the north by analyzing the acceleration data 51 and the directional data 61.

In the acceleration data 51 described in FIG. 9, the magnitude of the acceleration applied to the y axis of the position registration device 10 approaches the acceleration of gravity about 9.8 m/s². Specifically, it can be understood that the y axis of the position registration device 10 is being held in the vertical direction while the movement information is being detected. Therefore, the position specifying unit 23 determines that the y axis is the vertical direction and the x and z axes are in the horizontal direction.

The position specifying unit 23 then specifies the magnetic pole direction based on the advancing direction of the position registration device 10. For example, when the z axis direction of the position registration device 10 is the advancing direction, the position specifying unit 23 specifies the direction of the magnetic pole as seen from the z axis by calculating the arctan (z, x) from the magnetic forces of the x and z axes of the directional data 61. Actually, the direction changes minutely since the orientation of the position registration device 10 changes due to the walking motion by the user. Thus, in the present embodiment, the position specifying unit 23 calculates the magnetic flux density movement average in each direction and then specifies the movement direction with the calculated movement average values.

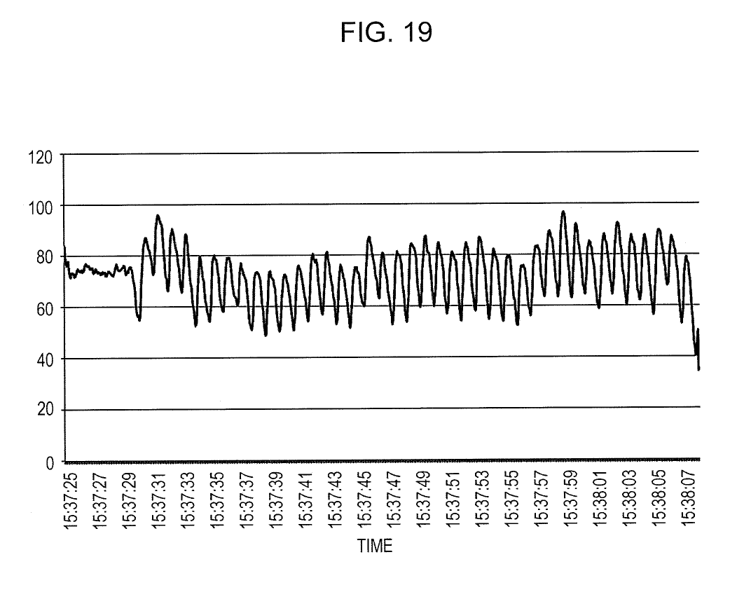

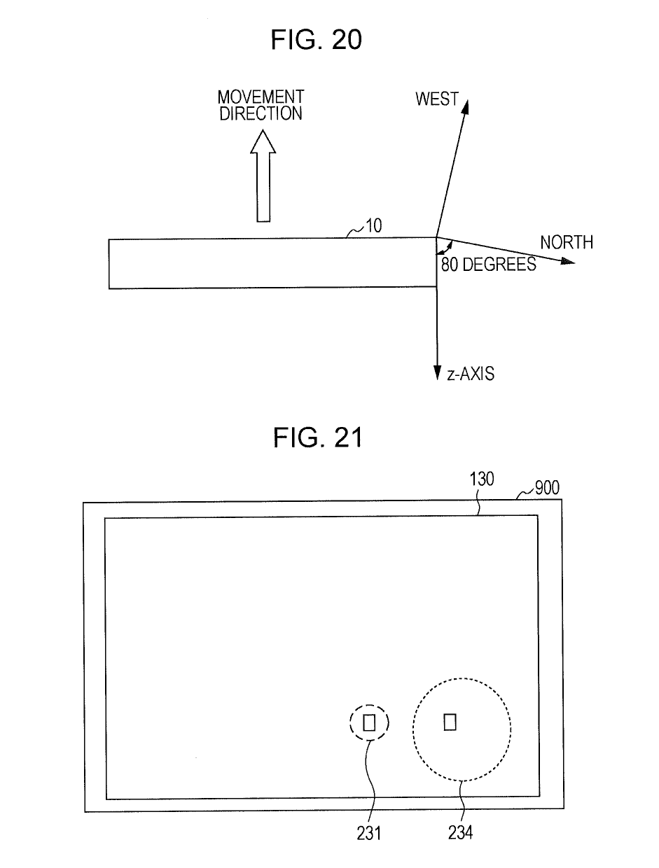

FIG. 19 is a graph of a time sequence of an angle in the northern direction as seen from the z-axis based on the directional data 61 illustrated in FIG. 10. It can be understood from the waveform illustrated in FIG. 19 that the northern direction as seen from the z axis is in a direction of about 80 degrees. Therefore, the position specifying unit 23 specifies that the movement direction of the position registration device 10 points in a west-southwest direction. FIG. 20 illustrates a relationship between the north direction and the axes of the position registration device 10.

Based on the abovementioned movement distance and the movement direction, the position specifying unit 23 specifies that the position registration device 10 moved in the west-southwesterly direction for a distance of 61.5 m during the period of time from the event occurrence time to the time the absolute position information was acquired. The position specifying unit 23 specifies the event occurrence position from the absolute position and the specified movement distance and movement direction, and then saves the specified event occurrence position (S24).

The position specifying unit 23 specifies the event occurrence position by, for example, conducting an inverse calculation of the estimated movement amount of the position registration device 10. The position specifying unit 23 establishes the position moved by the specified distance in the direction opposite the specified movement direction as the event occurrence position. The position specifying unit 23 establishes the coordinates of the position moved 61.5 m in an east-north easterly direction from the coordinates of the absolute position information as the event occurrence position. The position specifying unit 23 stores the event occurrence position in the event position table 33 in association with the event information.

The position specifying unit 23 may store the event occurrence position along with accuracy information related to the event occurrence position. An error is information that indicates a possibility of shifting of the specified event occurrence from an actual event occurrence position. In general, the error increases as the estimation time becomes longer. The position specifying unit 23 calculates the size of the error in response to the length of time from the event occurrence time to the time the absolute position information was acquired. A relationship between the length of time and the size of the error is defined beforehand. Moreover, if the holding of the position registration device 10 is changed, if the way the user walks is changed, or if the movement direction changes frequently, the error becomes larger.

When the position specifying unit 23 detects large fluctuations outside of walking or stopping from the movement information, specifying such portions of the movement distance and the movement direction may not be conducted. In this case, movement information that is not specified is stored as accuracy information. For example, the position specifying unit 23 calculates the entire movement speed from all of the calculated movement distances and from the period of time from the event occurrence time to the time the absolute position information was acquired. The position specifying unit 23 presumes that movement during the unspecified time was conducted at the calculated speed to calculate the accuracy information.

Multiple events may be stored in a multiple events table 31. In this case, the position specifying unit 23 reads out the event information records one at a time. The position specifying unit 23 extracts the event occurrence times from the read records. The position specifying unit 23 specifies the movement distance and the movement direction from the extracted event occurrence time to the time the absolute position information was acquired. The position specifying unit 23 specifies the event occurrence position from the specified movement distance, movement direction, and absolute position information. Therefore, the position specifying unit 23 can specify an event occurrence position for each event even if multiple items of event information are stored in the event table 31.

According to the position registration device 10 disclosed above, even when the timing of when a positioning event occurred is not known ahead of time, the utilization amount of electrical power can be reduced in comparison to a device that performs position acquisition constantly since the function to acquire the absolute position information and the function to acquire the movement information may only be conducted during the period of time to acquire the absolute position information after the positioning event has occurred.

Moreover, for example, when a radio IC tag attached to an object is read out and the object identification information and the object position information included in the read tag information are stored in association with each other, a user may read out the same object multiple times from the same position registration device 10. When multiple readings are conducted, a method for using the highly accurate information as position information may be considered instead of saving new position information as the position of that object.

The position registration device 10 stores the previously specified object position information in the event position table 33 in association with the object identification information.

The position registration device 10 can determine whether or not reading of the radio IC tag attached to the object was conducted in the past after specifying the reading position of the radio IC tag attached to the object. For example, the position registration device 10 can determine whether or not previous readings of the object are present by searching the records of the event position table 33 using the identification information of the object.

The position specifying unit 23 compares the previously specified position data with the currently specified absolute position. If the absolute position is equal to or less than a threshold, the object is considered to have not been moved, and the data with the shortest estimated movement distance and the smallest error among the past position data and the currently acquired position data is established as the newest object position. This is because, in general, it can be assumed that the shorter the specifying period of time is, the closer the position is to the event occurrence position.

FIG. 21 is an example of a screen indicating the position of an object. The position registration device 10 is assumed to have stored map information including coordinate data beforehand. The position registration device 10 receives a request to display the positions of the object 231 and the object 234 from a user. The processor 20 searches in the event contents 332 of the event position table 33 to extract the records of the objects 231 and 234.

The processor 20 specifies the event occurrence position of the object 231 and the event occurrence position of the object 234 and displays the positions on the display 110 along with the map information. The processor 20 may also display the accuracy information at this time. The processor 20 displays, for example, the accuracy information as a circle centered on the event occurrence position.

### Embodiment 2

In the first embodiment, time sequence movement information is acquired by the movement detecting unit 50 of the position registration device 10 from the event occurrence time to the time the absolute position information is acquired such that the movement distance and the movement direction are specified from the acquired time sequence movement information. In a second embodiment, the position specifying unit 23 acquires information of multiple absolute positions, derives a movement distance and a movement direction between the multiple absolute positions, and then derives an error of the specified movement distance and movement direction. The position specifying unit 23 corrects the movement direction and the movement distance from the event occurrence time up to the time the absolute position information is acquired based on the derived error. As a result, the position specifying unit 23 can more accurately specify the movement direction and the movement distance from the event occurrence time up to the time the absolute position information is acquired.

Processing of the position registration device 10 will be described next.

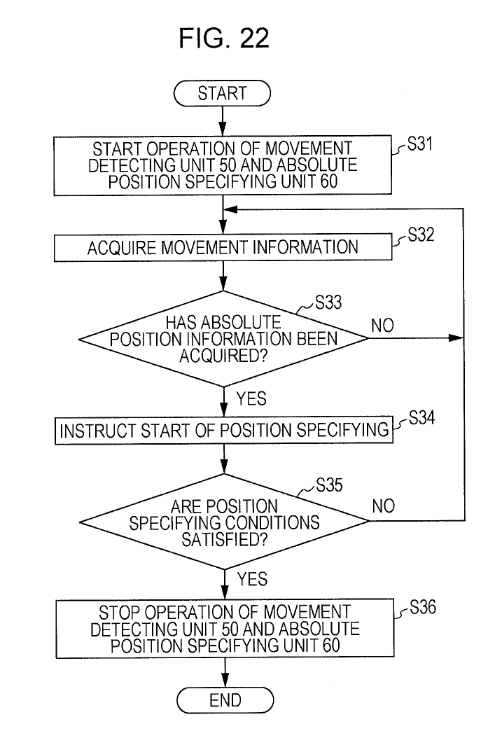

FIG. 22 is a flow chart of processing by the positioning control unit 22 according to the second embodiment. The positioning control unit 22 requests the movement detecting unit 50 and the absolute position specifying unit 60 to start positioning upon receiving an instruction to start positioning from the event management unit 21 (S31). The positioning control unit 22 periodically receives movement information from the movement detecting unit 50 (S32). The positioning control unit 22 determines whether or not the absolute position specifying unit 60 has detected the absolute position information (S33). If the absolute position information is not detected (S33: No), the positioning control unit 22 continues the operation in S32. If the absolute position information is detected (S33: Yes), the positioning control unit 22 instructs the position specifying unit 23 to start the processing to specify the event occurrence position (S34).

Next, the positioning control unit 22 determines whether or not position specifying conditions are satisfied (S35). The position specifying unit 23 determines whether or not the position specifying conditions are satisfied. The position specifying conditions are used to evaluate whether or not information (for example, information on length of stride or terminal orientation) that can be used for specifying a position maintains a likelihood at or above a threshold. The position specifying unit 23 derives, for example, statistical information of multiple movements from the information on the multiple absolute positions. The position specifying unit 23 derives a standard deviation of the information on the multiple movements acquired from the absolute position information. The position specifying unit 23 determines whether or not the movement information derived from the acceleration and the geomagnetic data maintains a likelihood at or above the threshold by determining whether or not the information falls within a certain range of the standard deviation. The position specifying conditions may or may not be acquired from information of a certain number or more of absolute positions.

If the position specifying conditions are not satisfied (S35: No), the positioning control unit 22 continues to acquire the movement information and the absolute position information. In the present embodiment, the position registration device 10 continues to acquire the movement information and the absolute position information until the position specifying conditions are satisfied after the first absolute position information has been captured. If the position specifying conditions are satisfied (S35: Yes), the positioning control unit 22 stops the operations of the movement detecting unit 50 and the absolute position specifying unit 60 (S36).

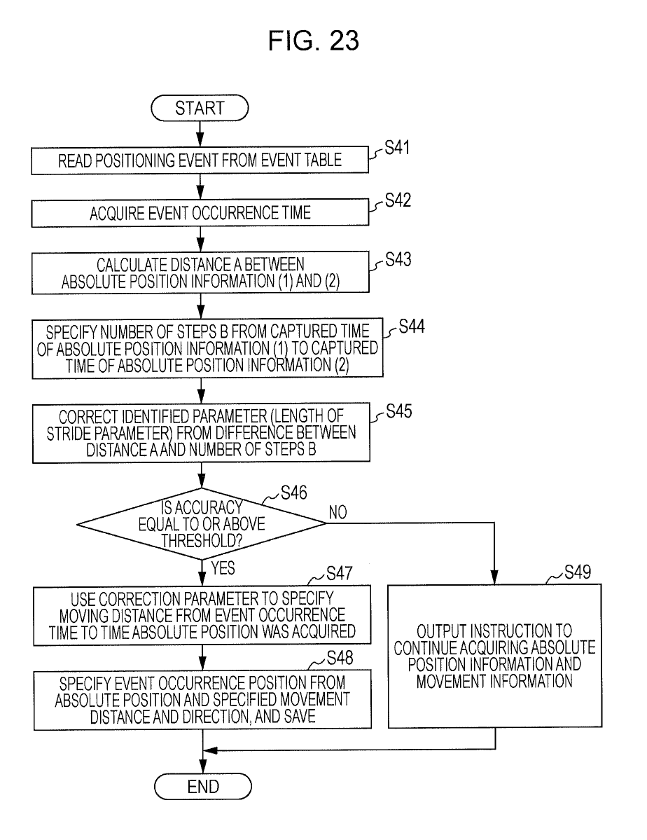

Processing of the position specifying unit 23 will be described next. FIG. 23 is a flow chart of processing by the positioning control unit 22 according to the second embodiment.

The position specifying unit 23 reads out a positioning event from the event table 31 (S41). The position specifying unit 23 extracts the time information at the time the event occurred (event occurrence time) from the read positioning event (S42). The position specifying unit 23 reads out the information of multiple absolute positions stored in the position table 32. If information on multiple absolute positions is not present, the position specifying unit 23 decides that the accuracy of the parameter is insufficient and outputs a request to continue positioning to the positioning control unit 22. The position specifying unit 23 calculates the distances between the multiple absolute positions (S43).

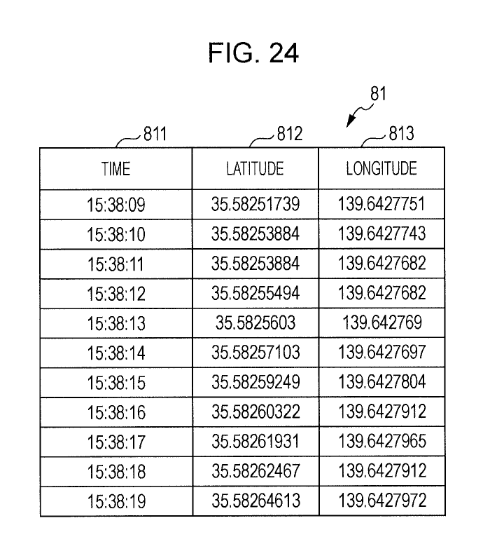

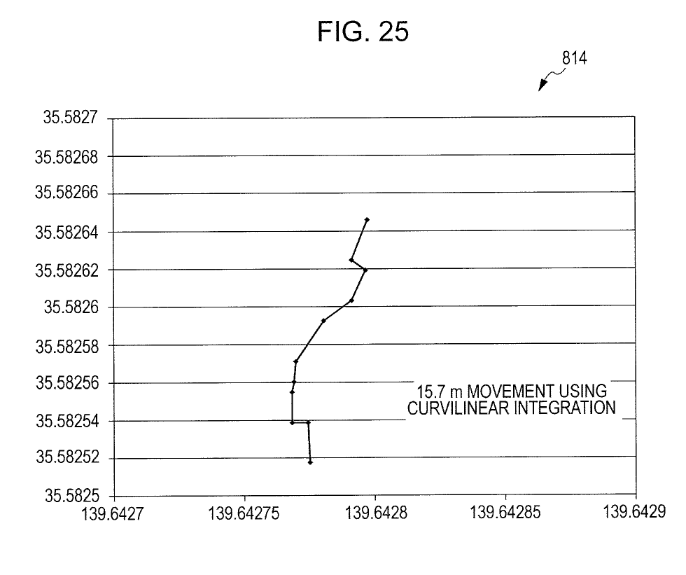

FIG. 24 is time sequence data of absolute position information continuously acquired by the positioning control unit 22. Time sequence data 81 of the absolute position information includes times 811 when the absolute position information is specified, and coordinate information (latitude 812, longitude 813) indicating absolute positions. The time sequence data 81 depicts acquired absolute position information from the time absolute position information was acquired at 15:38:09 up to 15:38:19. FIG. 25 is a graph 814 illustrating changes in absolute coordinates acquired from the time sequence data 81.

The position specifying unit 23 calculates a distance A by curvilinear integration of the absolute position information time sequence data 81 illustrated in FIG. 24. In the present embodiment, the position specifying unit 23 calculates the movement distance to be 15.7 m.

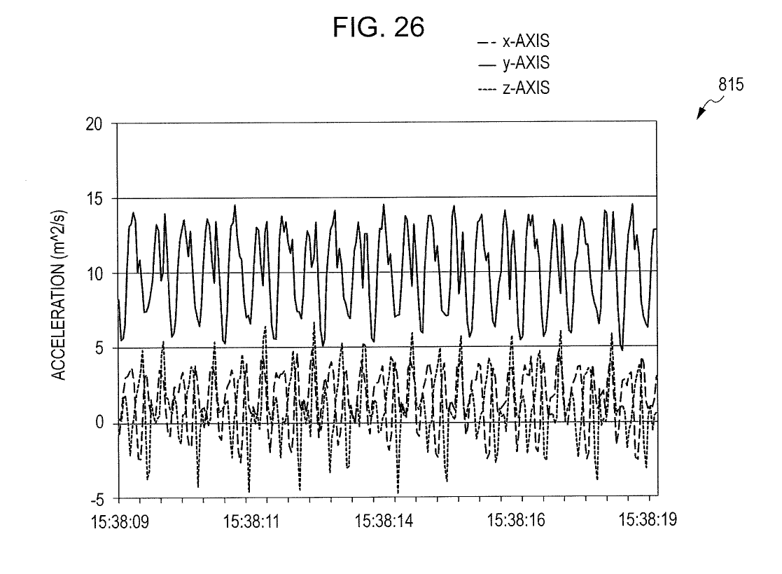

The position specifying unit 23 specifies the number of steps between the information on the multiple absolute positions from S43 from the above information (S44). FIG. 26 is a waveform of the acceleration data detected in the time period of the time sequence data in FIG. 24. The position specifying unit 23 specifies a number of steps B taken by the user between the absolute positions by extracting the amplitudes and cycles of the acceleration data. In the present embodiment, the position specifying unit 23 detects that the user took 21.5 steps in the time period corresponding to the time sequence in FIG. 24.

The position specifying unit 23 corrects a specifying parameter used to specify distances based on the distance A and the number of steps B (S45). Specifically, the position specifying unit 23 calculates the length of stride using the distance A between the absolute positions and the number of steps B derived from the movement information. The position specifying unit 23 updates the stored length of stride parameter to the calculated length of stride parameter. In the present embodiment, the length of stride is approximately 73 cm based on 15.7/21.5=0.73.

The position specifying unit 23 determines whether or not the accuracy of the corrected parameter satisfies a certain threshold (S46). For example, the position specifying unit 23 acquires a standard deviation beforehand from statistics on length of stride information. The position specifying unit 23 determines whether or not the accuracy of the corrected parameter is sufficient by determining whether or not the corrected length of stride parameter falls within a certain range of the standard deviation.

If the accuracy of the corrected parameter is not less than the threshold (S46: Yes), the position specifying unit 23 specifies the movement distance and the movement direction of the position registration device 10 from the event occurrence time to the time the absolute position information was acquired based on the corrected parameter, on the event occurrence time in the extracted event information, and on the movement information and the absolute position information stored in the position table 32 (S47). In the present embodiment, the same acceleration and geomagnetic data illustrated in FIGS. 9 and 11 of the first embodiment are acquired until the absolute position information is first detected. The position specifying unit 23 calculates the movement information and the movement distance using the acquired length of stride parameter. As a result, the movement distance is calculated as 0.73×82=59.9 m. The position specifying unit 23 uses the calculated movement distance as the specified movement distance from the event occurrence position to the absolute position.

The position specifying unit 23 specifies the event occurrence position from the absolute position and the specified movement distance and movement direction, and then saves the specified event occurrence position in the event position table 33 (S48). The position specifying unit 23 sends out a notification stating that the position specifying has been completed to the position registration device 22. The completion notification indicates that the position specifying conditions have been satisfied.

If the accuracy of the corrected parameter is below the threshold (S46: No), the position specifying unit 23 outputs a request to the positioning control unit 22 to continue acquiring absolute position information and movement information since the position specifying conditions are not satisfied (S49). If the accuracy of the corrected parameter is below the threshold, the position specifying unit 23 may return to using the uncorrected parameter as the length of stride parameter.

When the absolute position information is acquired from the absolute position specifying unit 60, the positioning control unit 22 of the present embodiment causes the movement detecting unit 50 and the absolute position specifying unit 60 to continue operating until a sufficient likelihood is acquired instead of stopping the operation of the movement detecting unit 50 and the absolute position specifying unit 60.

Instead of the position specifying unit 23 determining the likelihood, after the absolute position information value is initially acquired, the positioning control unit 22 may cause the positioning to continue for a certain period of time thereby allowing for the correction of the movement information of the position registration device 10 from the absolute position information and the movement information acquired during that certain period of time.

For example, the position specifying unit 23 detects the acceleration and directional data during the period from when information of a first absolute position is acquired until information of a second absolute position is acquired. The position specifying unit 23 uses the acceleration and directional data to specify a movement direction A of the position registration device 10. The position specifying unit 23 uses the information of the first and second absolute positions to specify a movement direction B from the first absolute position toward the second absolute position. The position specifying unit 23 specifies an angular difference between the movement direction A and the movement direction B. The position specifying unit 23 uses the specified angular difference to correct the movement direction from the point of time the event was detected to the point of time the absolute position was captured.

Moreover, the position registration device 10 may continue to perform positioning until either one of the conditions of the likelihood or time period is satisfied.

### Embodiment 3

Radio field intensity is used for positioning of absolute position information in the first and second embodiments. Acquiring the absolute position information may be accomplished in another way. In a third embodiment, an acquiring method including a way of detecting positions beforehand in a surrounding environment is described. Specifically, a position registration device 200 of the third embodiment specifies an absolute position by acquiring from outside installation location information of an identification information reader that has read information from a radio IC tag attached to the position registration device 200.

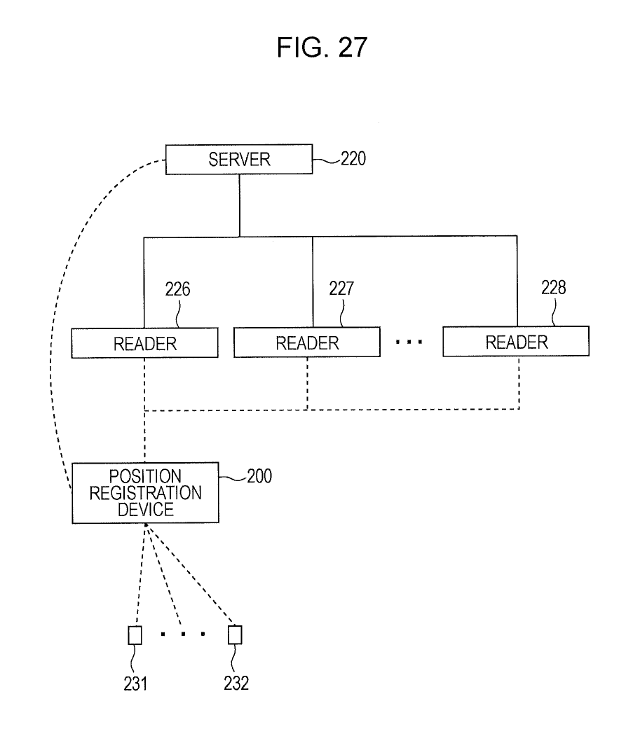

FIG. 27 describes a system according to the third embodiment. The system of the third embodiment includes the position registration device 200, a server 220, multiple identification information readers 226, 227, and 228, and multiple objects 231 and 232. The server 220 can send and receive data to and from the identification information readers 226, 227, and 228. Moreover, the server 220 and the position registration device 200 can send out and receive data through a wireless LAN and the like.

The identification information readers 226, 227, and 228 are devices that can read tag information of a radio IC tag 211 of the position registration device 200. The installation locations of each of the identification information readers 226, 227, and 228 are assumed to have been previously specified and the absolute position information of the installation locations is assumed to have been previously defined. The identification information readers 226, 227, and 228 each have identification information.

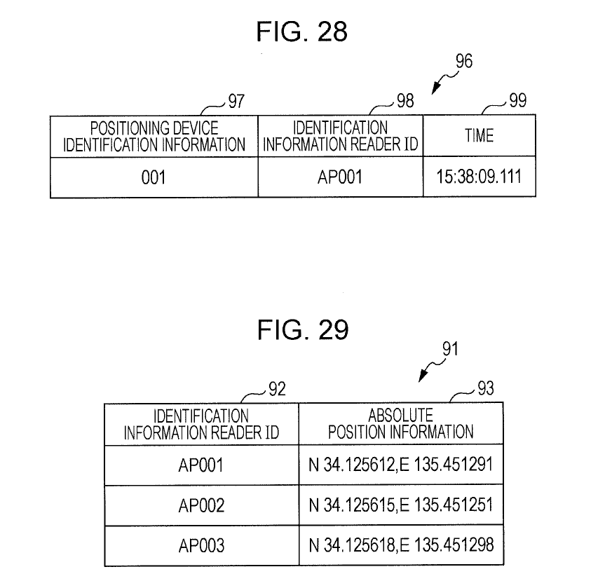

The identification information readers 226, 227, and 228 send out the read information to the server 220. FIG. 28 is an example of the read information. Read information 96 is information of identification information 97 of the position registration device 200, associated with an identification information reader ID 98 that identifies the identification information reader 226, 227, or 228, and a reading time 99 when the radio IC tag 211 of the position registration device 200 was read by an identification information reader. The server 220 stores the read information received from the identification information readers 226, 227, and 228.

The server 220 stores the installation location information of the identification information readers 226, 227, and 228. FIG. 29 is an example of installation location information. Installation location information 91 includes an identification information reader ID 92 that identifies the identification information reader 226, 227, or 228, and absolute position information 93 that indicates the absolute position information on the installed position of the identification information reader. The server 220 can communicate data with the position registration device 200 through, for example, a wireless LAN and the like.

The objects 231 and 232 are objects for stocktaking. A radio IC tag is attached to each of the objects 231 and 232. The position registration device 200 conducts object stocktaking by reading information of the radio IC tags attached to the objects 231 and 232.

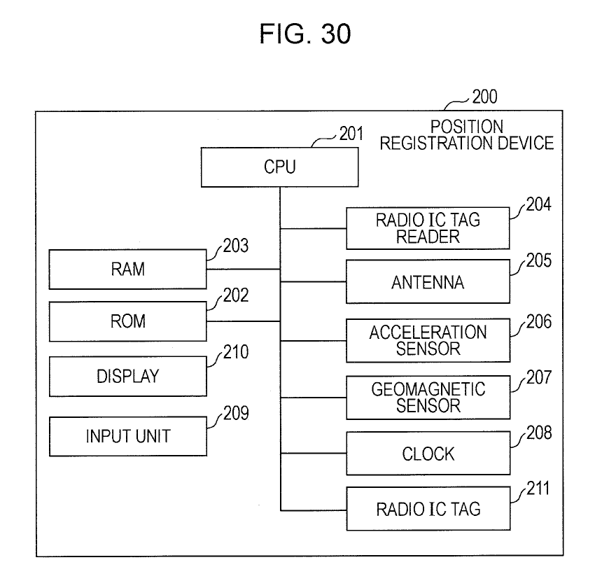

The position registration device 200 is a device having a positioning function. FIG. 30 is an example of a hardware configuration of the position registration device 200 according to the third embodiment. A CPU 201, a ROM 202, a RAM 203, a radio IC tag reader 204, an antenna 205, an acceleration sensor 206, a geomagnetic sensor 207, a clock 208, an input unit 209, and a display 210 respectively correspond to the CPU 101, the ROM 102, the RAM 103, the radio IC tag reader 104, the antenna 105, the acceleration sensor 106, the geomagnetic sensor 107, the clock 108, the input unit 109, and the display 110 of the position registration device 10 of the first embodiment. A radio IC tag 211 is attached to the position registration device 200. The radio IC tag 211 includes identification information for identifying the tag as tag information. The position registration device 200 can be identified based on the tag information.

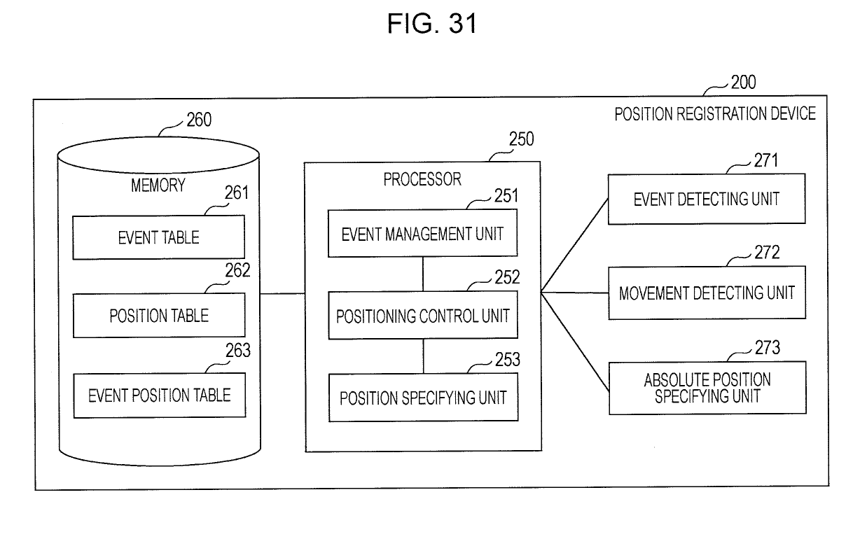

FIG. 31 is a functional block diagram of the position registration device 200.

The position registration device 200 includes a processor 250, a memory 260, an event detecting unit 271, a movement detecting unit 272, and an absolute position specifying unit 273 that respectively correspond to the processor 20, the memory 30, the event detecting unit 40, the movement detecting unit 50, and the absolute position specifying unit 60 of the position registration device 10 of the first embodiment.

The processor 250 includes an event management unit 251, a positioning control unit 252, and a position specifying unit 253 that respectively correspond to the event management unit 21, the positioning control unit 22, and the position specifying unit 23 of the position registration device 10 of the first embodiment. The memory 260 includes an event table 261, a position table 262, and an event position table 263 that respectively correspond to the event table 31, the position table 32, and the event position table 33 of the memory 30 in the position registration device 10 of the first embodiment.

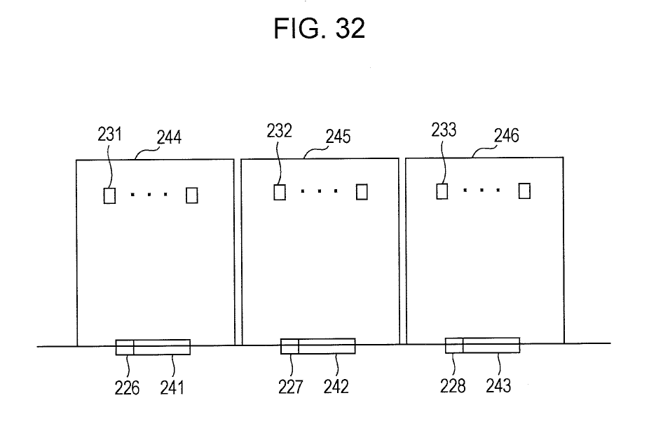

FIG. 32 is an example of an indoor environment according to a third embodiment. Reference numerals 244, 245, and 246 are rooms. The rooms 244, 245, and 246 have doors 241, 242, and 243 respectively. The identification information readers 226, 227, and 228 are respectively provided on the doors 241, 242, and 243. Stocktaking objects 231, 232, and 233 are placed in the rooms 244, 245, and 246 respectively. In the present embodiment, the identification information readers 226, 227, and 228 are installed near the doors of each of the rooms.

Processing according to the third embodiment will be described next.

When a user enters or exits a room, the radio IC tag 211 of the position registration device 200 is read out by an identification information reader installed near the door. The identification information readers 226, 227, and 228 detect entrances and exits to and from the rooms 244, 245, and 246 by reading out the radio IC tag 211 of the position registration device 200. Detecting whether or not the action of the user going through the door is an entrance or an exit can be achieved by providing readers on both sides of the doors. Additionally, an initial reading can be determined as an entrance and a second reading can be determined as an exit. The identification information readers send out to the server 220 the identification information of the radio IC tag 211 that was detected when the user passed through the door, the identification information of the identification information reader, and the read information that includes the time of the reading.

The following explanation is based on an example in which the identification information reader 226 reads out the radio IC tag 211 of the position registration device 200.

Under normal circumstances, the functions of the movement detecting unit 272 and the absolute position specifying unit 273 of the position registration device 200 are stopped. In the present embodiment, the position registration device 200 does not supply electrical power to the acceleration sensor or the geomagnetic sensor corresponding to the movement detecting unit 272, or to a communication unit or the radio IC tag 211 corresponding to the absolute position specifying unit 273.

The user causes the tag of the position registration device 200 to be read out by the identification information reader 226. For example, the identification information reader 226 is normally in a reading state and reads out the tag information of the radio IC tag 211 when the radio IC tag 211 of the position registration device 200 is detected as being nearby.

The user moves to a location near the object 231 in the room 244 holding the position registration device 200. When an instruction to read out the radio IC tag attached to the object 231 is received from the user, the position registration device 200 reads out the tag information of the radio IC tag attached to the object 231 using the radio IC tag reader 204.

When the event to read out the radio IC tag information is detected by the event detecting unit 271, the event management unit 251 stores the event information in the event table 261. The event management unit 251 instructs the positioning control unit 252 to start positioning.

The positioning control unit 252 outputs a request to start acquiring movement information to the movement detecting unit 272 and the absolute position specifying unit 273.

The movement detecting unit 272 supplies electrical power to the acceleration sensor and the geomagnetic sensor to start acquiring the acceleration and geomagnetic data.

The absolute position specifying unit 273 supplies electrical power to the communication unit. The communication unit periodically asks the server 220 for the read information (door passage information) indicating passage through the door. The positioning control unit 252 continues to acquire the acceleration data and the geomagnetic data and to ask for the door passage information until a response of the door passage information is received from the server 220. The positioning control unit 252 stores the acquired acceleration data and the geomagnetic data in the event table 262.

Here it is assumed that the user holds the position registration device 200 when passing through the door 241 to exit the room 244. The identification information reader 226 sends out to the server 220 the read information including the identification information of the position registration device 200 and the reading time. The server 220 records the received read information.

The position registration device 200 periodically accesses the server 220 to request acquiring absolute position information. The request to acquire the absolute position is conducted, for example, with the following procedures. The position registration device 200 sends the identification information of the position registration device 200 to the server 220. The server 220 searches for records including the received identification information in the read information. The server 220 specifies the identification information reader from the search results. The server 220 searches for the absolute position information of the specified identification information reader 226 from the installation location information 91. Additionally, the server 220 specifies the read time from the read information 96 records. The server 220 sends the absolute position information 93 of the specified identification information reader 226 and the read time 99 to the position registration device 200.

Although the asking the server 220 by the position registration device 200 is conducted periodically in the present embodiment, the asking may also be conducted, for example, when the acceleration data exceeds a certain amount. As described above, the position registration device 200 can acquire absolute position information at the reading time.

When the absolute position information and the reading time information is received from the server 220, the absolute position specifying unit 273 outputs to the positioning control unit 252 an indication that the absolute position information has been acquired. The positioning control unit 252 instructs the movement detecting unit 272 to stop acquiring movement information. The movement detecting unit 272 stops the supply of electrical power to the acceleration sensor and the geomagnetic sensor.

The position registration device 200 stores the acquired position information of the identification information reader as the sensor value 324, the reading time as the time 322 of the position table 32, and the sensor type 323 in the position event table 262 as the absolute position information.

The positioning control unit 252 outputs a request to start position specifying to the position specifying unit 253. The position specifying unit 253 then conducts the processing to specify the event occurrence position. The processing to specify the position is the same as in the first embodiment and will be omitted here.

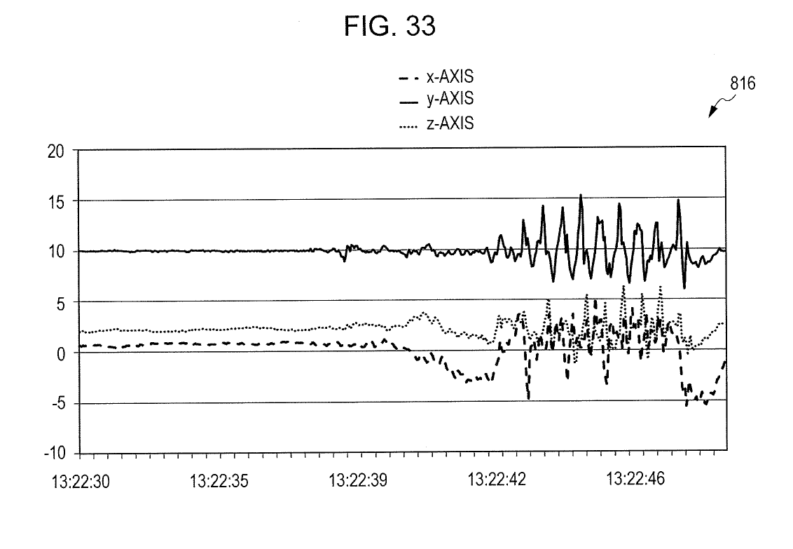

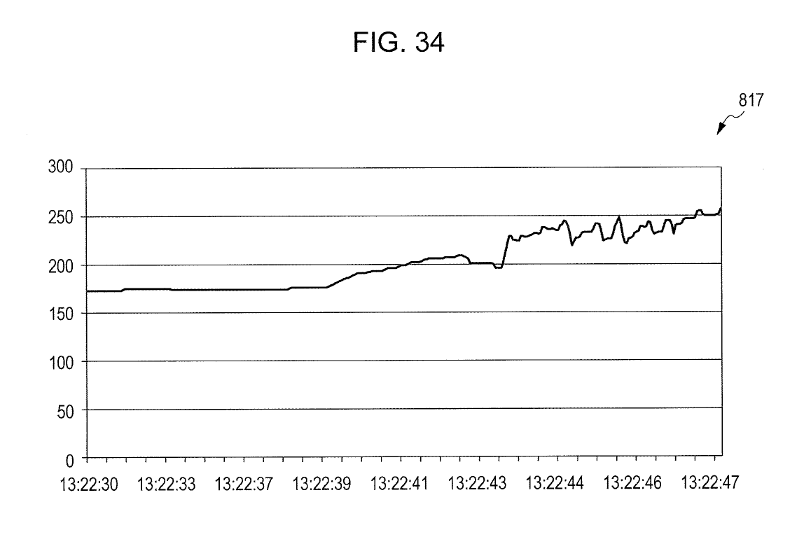

FIG. 33 is an example of a graph 816 of acceleration data at the time of or after the position registration device 200 reads a radio IC tag of the object 231. FIG. 34 is an example of a graph 817 of directional data at the time of or after the position registration device 200 reads out the radio IC tag of the object 231. In FIGS. 33 and 34, it is assumed that the position registration device 200 detects the radio IC tag of the object 231 at 3:22:30. The identification information reader 226 reads out the radio IC tag 211 of the position registration device 200 at 3:22:47 which indicates that the position registration device 200 passed through the door 241. The FIGS. 33 and 34 indicate that 9 steps were taken in an east-northeasterly direction between 13:22:42 and 13:22:47. The position specifying unit 253 specifies that the object 231 was at a position 9 (steps)×0.75 m (length of stride)=6.75 m west-southwest of the door 241.

The position registration device of the present embodiment may be a portable terminal such as a camera, a video camera, a smartphone, or a portable telephone and the like. If the position registration device is a camera, a video camera, a smartphone, or a portable telephone and the like, the occurrence of an event can be determined when, for example, a signal to take a photograph is detected. Additionally, if the position registration device is a smartphone or a portable telephone, the occurrence of an event can be determined when, for example, the reception of a phone call from another party, an email, or a position information confirmation request is detected. Furthermore, the above processing can be conducted by the mobile terminal executing an application program. As described above, the position registration device can be provided as one device that is a combination of functions to conduct events.

Moreover, in the present embodiments, the position registration device 10 conducts processing to stop positioning functions during normal times. However, the above processing may be conducted when an event occurs in between intermittent positioning processing of the position registration device 10. Also according to the present embodiments, the position registration device 10 stops the positioning functions during normal times by not supplying electrical power to the positioning functions. However, the positioning functions may be placed in an idle mode state if the positioning functions have an idle mode. Whether to stop the supply of electrical power to all of the positioning functions or merely to a portion of the positioning functions depends on the device, and therefore an appropriate amount of electrical power may be controlled.

Moreover, when the positioning functions are constantly activated and absolute position information is acquired, the position registration device 10 may specify the event occurrence position from the movement amount during the time period from after the event occurrence to the acquisition of the absolute position.

The position registration device 10 specifies the movement distance and the movement direction of the position registration device 10 from acceleration and geomagnetism. The position registration device 10 of the present embodiments detects the walking state of the user from the acceleration waveform to specify the distance from the number of steps. However, if, for example, the acceleration noise is small, the position registration device 10 may calculate the speed and movement distance from the integral of the acceleration. Additionally, the position registration device 10 may activate a camera function to specify the speed from information of a photograph taken by the camera and then calculate the movement distance.

An absolute position of the present embodiment indicates a position specified by acquiring information from outside that allows for the specification of a position of the position registration device. For example, the position registration device specifies the absolute position from radio field intensity, GPS, or an IC tag reader location. However, information that can specify a position is not limited to the above, and IC tag or bar-code information that clarifies a position may be used.

As described above, the position registration device 10 and the position registration device 200 are able to specify an event occurrence position even if the acquisition of absolute position information is started after the event occurrence.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A position registration apparatus that records a position where an event occurs, the apparatus comprising:
a detecting unit that detects an event occurrence;
a first position specifying unit that specifies a first position by acquiring, from outside of the position registration apparatus, information that specifies a position;
a movement detecting unit that detects an amount of movement of the position registration apparatus;
a memory that accumulates the amount of movement detected by the movement detecting unit as movement information at least not before the detected event occurrence; and
a second position specifying unit that, when the first position of the position registration apparatus is detected by the first position specifying unit, specifies the amount of movement of the position registration apparatus from a point of time of the event occurrence up to a point of time of the information that specifies a position acquired from outside of the position registration apparatus, and specifies a second position of the position registration apparatus at the point of time of the event occurrence based on the first position of the position registration apparatus specified by the first position specifying device and from the specified amount of movement of the position registration apparatus.

2. The position registration apparatus according to claim 1, wherein the second position specifying unit starts specifying the second position when the detecting unit detects the event occurrence.

3. The position registration apparatus according to claim 2, wherein the movement detecting unit starts detecting the movement information when the detecting unit detects the event occurrence.

4. The position registration apparatus according to claim 3, wherein detection of the movement information by the movement detecting unit and specifying of the first position by the first position specifying unit is stopped after at least the information that can specify the position device is acquired from outside of the position registration.

5. The position registration apparatus according to claim 1, wherein
the first position specifying unit specifies the first position a plurality of times, and
the second position specifying unit corrects a parameter for calculating the amount of movement of the position registration apparatus detected by the movement detecting unit, based on the multiple first positions of the position registration apparatus specified by the first position specifying unit.

6. The position registration apparatus according to claim 1, wherein
the movement detecting unit detects as the movement information a three-directional acceleration applied to the position registration apparatus from a triaxial acceleration sensor and a three-directional magnetic flux density of the position registration apparatus from a triaxial geomagnetic sensor, and
acquires a direction of the position registration apparatus by detecting a gravitational force direction from an output of the acceleration sensor, by specifying a horizontal plane from the detected gravitational force direction, and by specifying a magnetic flux density corresponding to the specified horizontal plane from the geomagnetic sensor.

7. The position registration apparatus according to claim 1, wherein the movement detecting unit detects as the movement information an acceleration applied to the position registration apparatus by a three-direction acceleration sensor from a triaxial acceleration sensor, and acquires a movement distance of the position registration apparatus by detecting a gravitational force direction from an output of the acceleration sensor and specifying a number of steps from an acceleration waveform.

8. The position registration apparatus according to claim 1 further comprising:
a radio IC tag, wherein
the second position specifying unit specifies the second position of the position registration apparatus from a position of a radio IC tag reader by detecting that the radio IC tag was read by the radio IC tag reader previously having position information.

9. A non-transitory, computer readable storage medium storing a position registration program causing a position registration apparatus to measure positions according to a process comprising:
detecting an event occurrence;
specifying a first position by acquiring, from outside, information that can specify a position;
detecting an amount of movement of the position registration apparatus as movement information;
accumulating the movement information detected at least not before the detected event occurrence; and
when the first position of the position registration apparatus is acquired, causing the position registration apparatus to conduct processing to specify the amount of movement of the position registration apparatus from a point of time of the event occurrence to a point of time where the information that specifies a position of the position registration apparatus from the point of time of the event occurrence acquired from outside of the position registration apparatus, and to specify a second position of the position registration apparatus at the point of time of the event occurrence based on the specified first position of the position registration apparatus and from the specified amount of movement of the position registration apparatus.

10. A method of controlling a position registration apparatus to measure positions comprising:
detecting an event occurrence by the position registration apparatus;
specifying a first position by acquiring, from outside, information that can specify a position;
detecting an amount of movement of the position registration apparatus as movement information;
accumulating the movement information detected at least not before the detected event occurrence; and
when the first position of the position registration apparatus is acquired, causing the position registration apparatus to conduct processing to specify the amount of movement of the position registration apparatus from a point of time of the event occurrence to a point of time where the information that can specify a position of the position registration apparatus from the point of time of the event occurrence acquired from outside of the position registration apparatus, and to specify a second position of the position registration apparatus at the point of time of the event occurrence based on the specified first position of the position registration apparatus and from the specified amount of movement of the position registration apparatus.
